(19) United States
(12) Patent Application Publication
(10) Pub. No.: US 2016/0311309 A1
(43) Pub. Date: Oct. 27, 2016

(54) POWERTRAIN WITH A VARIABLE-SPEED TRANSMISSION DEVICE,IN PARTICULAR FOR A HYBRID VEHICLE

(71) Applicant: IFP ENERGIES NOUVELLES, Rueil-Malmaison (FR)

(72) Inventor: Stéphane VENTURI, ROIFFIEUX (FR)

(21) Appl. No.: 15/103,569

(22) PCT Filed: Nov. 26, 2014
(86) PCT No.: PCT/EP2014/075698

§ 371 Date: Jun. 10, 2016

(30) Foreign Application Priority Data
Dec. 10, 2013 (FR) 13 623 65

(51) Int. Cl. B60K 6/547; B60K 6/365; B60K 6/383; F16H 3/72

(52) U.S. Cl. CPC B60K 6/547; F16H 3/725; B60K 6/365; B60K 6/383; F16H 2200/2064; F16H 2200/2094; F16H 2200/2069; F16H 2200/2084; Y10S 903/911; Y10S 903/913; Y10S 903/919; B60Y 2200/92; B60Y 2400/427; B60Y 2400/73

(57) ABSTRACT

The invention is a powertrain for a hybrid type motor vehicle comprising a driving/receiving machine (20), a thermal engine (10), a speed variation device (14) including an engine epicyclic gear train (24) with a sun gear (34) and a crown (46), each connected to engine shaft (12) by a controlled clutch (26, 28) and to a fixed part (44) of the vehicle by a one-way automatic clutch (30, 32) and a planet gear carrier, (52) and another epicyclic gear train (68) arranged on a shaft (70) substantially parallel to engine shaft (12) and connecting engine epicyclic gear train (24) to a transmission track (90, 92) for motion transmission to a drive axle (16). The powertrain comprises a thermal reverse control device (111, 130) for reversing the direction of rotation of planet gear carrier (80) of the other epicyclic gear train (68) from the rotation of planet gear carrier (52) of engine epicyclic gear train (24).

### CROSS REFERENCE TO RELATED APPLICATIONS

Reference is made to PCT Application PCT/EP2014/075698 filed Nov. 26, 2014, and French Patent Application No. 13/62.365 filed Dec. 10, 2013, which are incorporated herein by reference in their entirety.

### BACKGROUND OF THE INVENTION

1. Field of the Invention

The present invention relates to a powertrain with a variable-speed transmission device, in particular for a hybrid vehicle.

2. Description of the Prior Art

As it is already known, a hybrid vehicle comprises a powertrain that uses, alone or in combination, as a traction/propulsion drive, an internal-combustion engine with a variable-speed transmission and/or a driving/receiving machine such as a rotary electric machine connected to an electric source, such as one or more batteries. This combination affords the advantage of optimizing the performance of the vehicle to both reduce the discharge of emissions to the atmosphere and to decrease the fuel consumption. Thus, when the vehicle is to be driven with a high torque over a wide speed range while limiting exhaust gas and noise generation, as in an urban site, the electric machine is preferably used for driving this vehicle. On the other hand, the thermal engine is used for driving this vehicle for uses where a high driving power and a wide operating range are required.

### BACKGROUND OF THE INVENTION

From French patent application No. 2,955,165 filed by the applicant, describes a motor vehicle powertrain comprising a thermal engine with a shaft connected to a variable-speed transmission including an epicyclic gear train with a sun gear and a crown connected each to the thermal engine shaft by a controlled clutch and to a fixed part of the powertrain by a one-way automatic clutch, and a planet gear carrier transmitting the speed variation to the drive axle of the vehicle through a transmission track.

In order to increase the speed variation capacity when the vehicle is driven by the electric machine, the applicant has combined the variable-speed transmission device of the aforementioned document with another epicyclic gear train connecting the engine epicyclic gear train to a transmission track for motion transmission to the drive axle of this vehicle, as described in French patent application No. 2,962,697 filed by the applicant.

Thus, the speed transmission device described in the aforementioned applications allows achieving three forward gear ratios of the vehicle by use of the thermal engine and two forward gear ratios by use of the electric motor, one of which can be for reverse motion of the vehicle.

Although satisfactory, this transmission device involves a significant drawback.

Indeed, reverse gear of the vehicle is achieved only through the electric motor. When the driver wants to shift into reverse, it may happen that the electric source (batteries) no longer has sufficient capacity to power this electric motor in order to perform this gear change.

It is therefore necessary to either perform complicated and tedious maneuvers in forward gear to obtain the desired result, or to wait for a sufficient battery recharge level to be able to put the vehicle in reverse.

The present invention overcomes this drawback by means of a variable-speed transmission device allowing the vehicle to be put into reverse using the thermal engine.

### SUMMARY OF THE INVENTION

The invention therefore relates to a powertrain for a hybrid type motor vehicle comprising a driving/receiving machine, a thermal engine, a speed variation device including an engine epicyclic gear train with a sun gear and a crown, each connected to the engine shaft by a controlled clutch and to a fixed part (44) of the powertrain by a one-way automatic clutch and a planet gear carrier, and another epicyclic gear train arranged on a shaft substantially parallel to the engine shaft and connecting the engine epicyclic gear train to a transmission track for motion transmission to a drive axle, characterized in a thermal reverse control device for reversing the direction of rotation of the planet gear carrier of the other epicyclic gear train from the rotation of the planet gear carrier of the engine epicyclic gear train.

The reverse control device can comprise a connecting gear wheel fixedly mounted on the shaft meshing with a reverse gear wheel free in rotation and axially mobile on a gear wheel pin.

The reverse gear wheel can comprise a toothed strip for cooperating with an additional toothed strip of the planet gear carrier of the engine epicyclic gear train and with a toothed strip of the connecting gear wheel of the shaft.

The reverse control device can comprise a connecting gear wheel mounted to by free rotate and fixed in translation on a gear wheel shaft, and a reverse gear wheel mounted to free rotate and axially fixed on the shaft.

The connecting gear wheel of the shaft can comprise a toothed strip for cooperating with an additional toothed strip of the planet gear carrier of the engine epicyclic gear train and with a toothed strip of the reverse gear wheel.

The reverse control device can comprise means for locking the shaft in rotation.

The locking means can comprise a coupling surface carried by the reverse gear wheel and a coupling surface carried by a fixed element of the powertrain.

The locking means can comprise a coupling surface carried by an actuator, fixed in rotation and free in translation on the shaft, and a coupling surface carried by a fixed element of the powertrain.

The actuator can furthermore comprise a coupling surface cooperating with a coupling surface linked to the reverse gear wheel.

The reverse control device can comprise means for controlling axial displacement of the reverse gear wheel.

The reverse control device can comprise means for controlling axial displacement of the actuator.

### BRIEF DESCRIPTION OF THE DRAWINGS

Other features and advantages of the invention will be clear from reading the description hereafter, given by way of non limitative example, with reference to the accompanying figures wherein:

FIG. 1 is a diagram showing a powertrain using a variable-speed transmission device according to the invention, and

FIG. 2 diagrammatically illustrates a variant of the powertrain of FIG. 1.

### DETAILED DESCRIPTION OF THE INVENTION

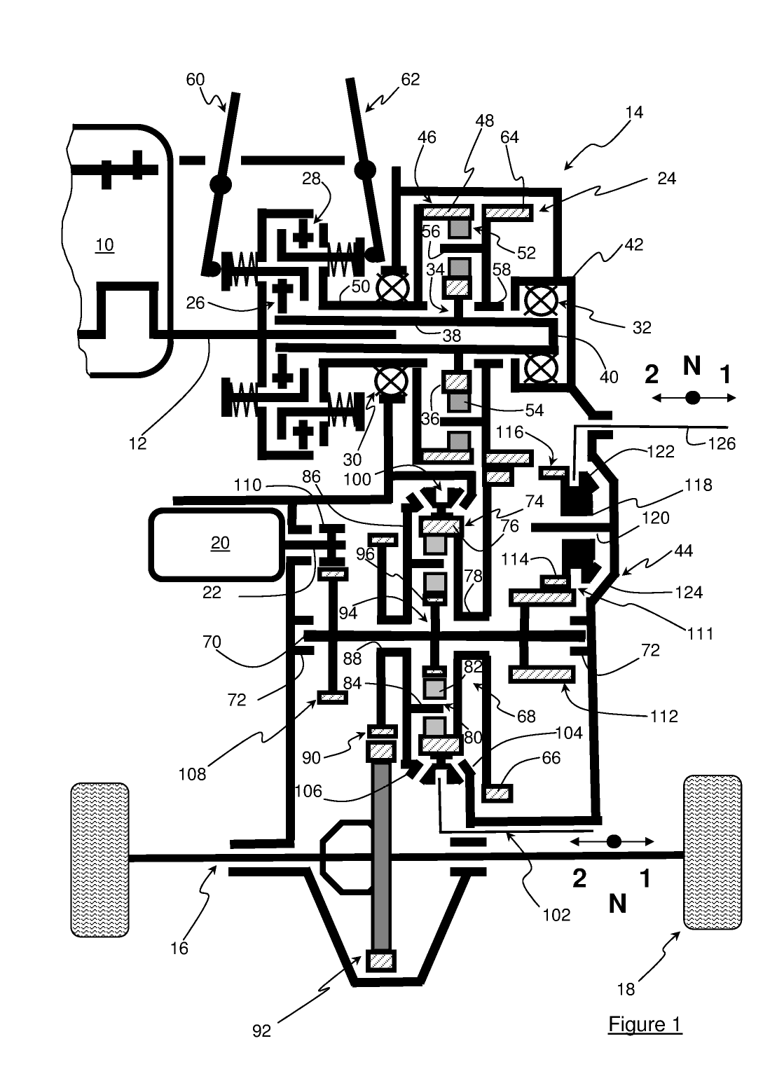

In FIG. 1, the powertrain comprises a thermal engine 10, notably an internal-combustion engine, with an engine shaft 12, coming from the crankshaft of the engine, a variable-speed transmission device 14 and a drive axle 16 which drives driving wheels 18 of the vehicle.

Engine shaft 12 also functions as a receiving shaft but, for description simplification reasons, this shaft is referred to as engine shaft to clearly distinguish it from the other shafts of the transmission device.

The powertrain also comprises a driving/receiving machine such as an electric motor 20 with a rotor 22 that can be used as an electric motor for driving the vehicle by being connected to an electrical power source, such as batteries (not shown) or as an electrical power generator and, more particularly, as an alternator for charging these batteries.

Speed variation device 14 comprises an epicyclic gear train 24, referred to as thermal engine epicyclic gear train, with two controlled clutches 26, 28, here and friction clutches, and two one-way automatic clutches, such as free wheels 30, 32.

More precisely, engine epicyclic gear train 24 comprises a sun gear 34 with an externally strip 36 having teeth and carried by a hollow shaft 38, referred to as sun gear shaft, which surrounds engine shaft 12 while being freely rotatable but fixed in translation with respect thereto. Free end 40 of this shaft rests on a bearing 42 carried by a fixed part 44 of the powertrain through free wheel 32, referred to as sun gear free wheel, which allows rotation of the sun gear in only one direction.

This gear train also comprises a crown 46 with an internal strip 48 having teeth mounted concentrically relative to the sun gear, and connected to a hollow shaft 50, referred to as crown shaft, surrounding sun gear hollow shaft 38 which is free to rotate, but fixed in translation with respect thereto. This crown is externally connected to fixed element 44 of the vehicle powertrain by one-way clutch 30, referred to as crown free wheel, which allows rotation of the crown in only one direction.

Of course, the two free wheels 30 and 32 are mounted so that sun gear 34 and crown 46 can rotate only in the same direction, and preferably in the same direction as engine shaft 12.

Finally, this engine epicyclic gear train comprises a planet gear carrier 52 advantageously having three planet gears 54 having external toothed wheels, arranged in the same angular interval with respect to one another (120° here) and meshing with the crown and the sun gear.

Strip 48 of the crown, strip 36 of the sun gear and planet gears 54 are therefore arranged in the same plane, here in a vertical plane of FIG. 1.

These planet gears are each carried by a horizontal pin 56 while being free in rotation, but fixed in translation thereon. These planet gear pins are connected to a tubular bearing 58, referred to as planet gear carrier bearing, surrounding sun gear shaft 38 while rotating freely thereon.

The free ends of the sun gear and crown shafts each carry a controlled clutch 26 and 28, preferably a friction clutch controlled each by a lever control 60 and 62.

Thus, clutch 26, referred to as sun gear clutch, allows coupling of the sun gear with engine shaft 12 while the purpose of clutch 28, referred to as crown clutch allows coupling of the crown with the engine shaft.

As is more visible in FIG. 1, planet gear carrier 52 also comprises an externally strip 64 with teeth arranged opposite the planet gears and connected by meshing with another externally toothed connecting strip 66 of another additional epicyclic gear train 68, referred to as machine epicyclic gear train.

This epicyclic gear train 68 is arranged on a fixed shaft 70, to be freely rotatable but fixed in translation, and substantially parallel to engine shaft 12, while being supported by two bearings 72 provided on fixed element 44 of the powertrain.

This machine epicyclic gear train comprises a crown 74 carrying connecting strip 66, as well as another internally toothed strip 76 opposite connecting strip 66. These strips are carried by a bearing 78 to be freely rotatable but fixed in translation on shaft 70.

The gear train also comprises a planet gear carrier 80 having advantageously three toothed wheel planet gears 82, carried by planet gear pins 84, mounted in the same angular interval with respect to one another (120° here) and meshing with the teeth of strip 76 of crown 74.

Planet gear pins 84 are carried by a plate 86 that is part of the planet gear carrier and comprises a tubular bearing 88 which is freely rotatable but fixedly to translation shaft 70.

This bearing 88 fixedly carries a driving gear wheel 90 that cooperates with another gear wheel 92 linked to drive axle 16. This assembly of two gear wheels thus forms a motion transmission track between machine epicyclic gear train 68 and axle 16.

The planet gears also cooperate by meshing with a sun gear 94 that comprises an external toothed strip 96 carried by a flange fixedly mounted on shaft 70.

Of course, like thermal engine epicyclic gear train 24, strip 76 of crown 74, toothed strip 96 of the sun gear and planet gears 82 are arranged in the same plane, here in a vertical plane considering FIG. 1.

Machine epicyclic gear train 68 also carries a controlled clutch 100, of double-effect actuator type, allowing its crown 74 to be connected either to plate 86 of planet gear carrier 80, or to fixed element 44 of the powertrain.

This actuator is controlled by a control 102 to provide two meshing positions (1, 2) and a neutral position (N). This actuator is carried to be fixed in rotation by the outer wall of strip 76 of crown 74 while being in axially translatable thereon. This actuator is designed to cooperate with either a fixed coupling surface 104 carried by a fixed element 44 of the powertrain, or with another coupling surface 106 carried by the peripheral end of plate 86.

Thus, under the effect of the control, the actuator can achieve coupling of crown 74 with fixed element 44 (position 1), with planet gear carrier 80 (position 2) or be in neutral position (position N) without being connected with any of the two coupling surfaces.

Shaft 70 also fixedly carries a gear wheel 108 that cooperates with another gear wheel 110 which is fixedly carried by rotor 22 of the electric machine.

The rotational link between the two gear trains is thus provided by the cooperation of two toothed strips 64 and 66, which advantageously allows obtaining a rotation of axle 16 in the same direction as shaft 12 of thermal engine 10.

Opposite wheel 108, shaft 70 also carries a thermal reverse control device 111 allowing reversal of the direction of rotation of axle 16. This device comprises an externally toothed wheel 112 fixed in rotation and translatable on shaft 70. This connecting wheel meshes with an externally toothed strip 114 of a reverse gear wheel 116 carried by a tubular bearing 118 which is free in rotation and is translatable on a shaft 120 carried by fixed element 44 of the powertrain while being substantially parallel to shaft 70.

Advantageously, bearing 118 carries a locking coupling surface 122 for cooperating with a locking coupling surface 124 carried by fixed element 44 of the powertrain whose purpose is explained in the rest of the description.

The assembly made up of reverse gear wheel 116 and locking coupling surface 122 can move in translation on shaft 120 under the effect of a control 126 with a locking position (1) where this wheel is locked in rotation on the fixed element through the cooperation of the two coupling surfaces 122 and 124, a driving position (2) where strip 114 of wheel 116 meshes with additional strip 64 of planet gear carrier 52 and a neutral position (N) where the wheel is in contact with none of the coupling surfaces.

The various configurations of the powertrain as a whole are now described by way of example according to the traction/propulsion mode used.

For simplification reasons, only the configurations with traction/propulsion by the thermal engine or by the electric motor are mentioned.

When the vehicle is driven by electric motor 20, both clutches 26 and 28 are inactive, actuator 100 is in position 1 or 2, and reverse gear wheel 116 and locking coupling surface 122 are in neutral position (N).

As soon as electric motor 20 is powered, its rotor 22 is driven in rotation. This rotating motion is then transmitted to gear wheel 108 by gear wheel 110 of the rotor.

From this configuration, actuator 100 is controlled in one of positions 1 or 2 for driving axle 16 of the vehicle in rotation.

In position 1, the actuator is engaged with coupling surface 104 of fixed element 44 by immobilizing in rotation crown 74 of machine epicyclic gear train 68. The rotating motion of gear wheel 108 is thus transmitted to sun gear 94 and to planet gear carrier 80. This rotating motion of the planet gear carrier is subsequently transmitted to gear wheel 90, then to gear wheel 92 and to axle 16 for driving wheels 18 of the vehicle.

When actuator 100 is in position 2, engaged with coupling surface 106 of plate 86, crown 74 is linked in rotation to planet gear carrier 80. The rotation of sun gear 104 is thus transmitted to the crown/planet gear carrier assembly. The rotation of this assembly is transmitted to gear wheel 90 that cooperates with axle gear wheel 92 by thus driving the wheels of the vehicle in rotation.

The other configurations are described now to illustrate traction/propulsion of the vehicle by thermal engine 10 according to different forward gear ratios.

In these configurations, actuator 100 is either in neutral position or in position 2, while actuator 146 is kept in neutral position N and clutches 26 and 28 are either both in active position, or one or the other is in active position.

In the configuration where clutches 26 and 28 are both in active position, the rotation of shaft 12 of thermal engine 10 drives in rotation crown 46, sun gear 34 and therefore planet gear carrier 52 of engine epicyclic gear train 24. This rotation of the planet gear carrier is then transmitted to crown 74 of the other epicyclic gear train by strips 64 and 66.

When actuator 100 is in position 2, crown 74 and planet gear carrier 80 are linked to one another and they have a rotating motion. The planet gear carrier then drives axle 16 through wheels 90 and 92.

One or the other of the clutches can then be set to inactive position in order to obtain other speed ratios.

For the inactive position of clutch 26 and active position of clutch 28, the rotation of shaft 12 of thermal engine 10 drives in rotation crown 46 that drives in rotation planet gear carrier 52. This rotation of the planet gear carrier is then transmitted to crown 74 of machine epicyclic gear train 68 through the cooperation of strips 64 and 66.

Thus, when actuator 100 is in position 2, the rotating motion of crown 74 is transmitted to planet gear carrier 80, then to gear wheel 90 and to axle wheel 92.

When actuator 100 is in neutral position N, the rotation of crown 74 is transferred to planet gear carrier 80 and to sun gear 94 through planet gears 82. The planet gear carrier then drives axle 16 through the agency of wheels 90 and 92, and the sun gear drives machine 20 through the agency of wheels 108 and 110.

For the inactive position of clutch 28 and active position of clutch 26, the rotation of shaft 12 of thermal engine 10 drives in rotation sun gear 34. The rotation of the sun gear drives in rotation planet gear carrier 52, then crown 74 of machine epicyclic gear train 68.

From this configuration, the motion transmission path is as described in connection with the inactive position of clutch 26 for positions N or 2 of actuator 100.

In the configuration where control 126 actuates the assembly made up of gear wheel 112/coupling surface 122 in position 1, the rotation of shaft 70 carrying sun gear 94 of machine epicyclic gear train 68 is locked.

In this configuration, the machine epicyclic gear train is used as a reducer and a shorter gearing down is achieved when using the thermal engine with its three speed ratios.

In order to put the vehicle in reverse using only the thermal engine, control 126 is actuated in position 2 so that reverse gear wheel 116 moves on gear wheel 112 and meshes with additional strip 64 of engine epicyclic gear train 24.

Thus, planet gear carrier 52 of engine epicyclic gear train 24 is connected to sun gear 94 of the machine epicyclic gear train through wheel 116 and to crown 74 of the machine epicyclic gear train.

This allows obtaining a rotation of planet gear carrier 80 of machine epicyclic gear train 68 that is reverse to that of engine epicyclic gear train 24.

This reverse rotating motion is then transmitted to gear wheels 90 and 92 and to axle 16 by travelling the vehicle in reverse.

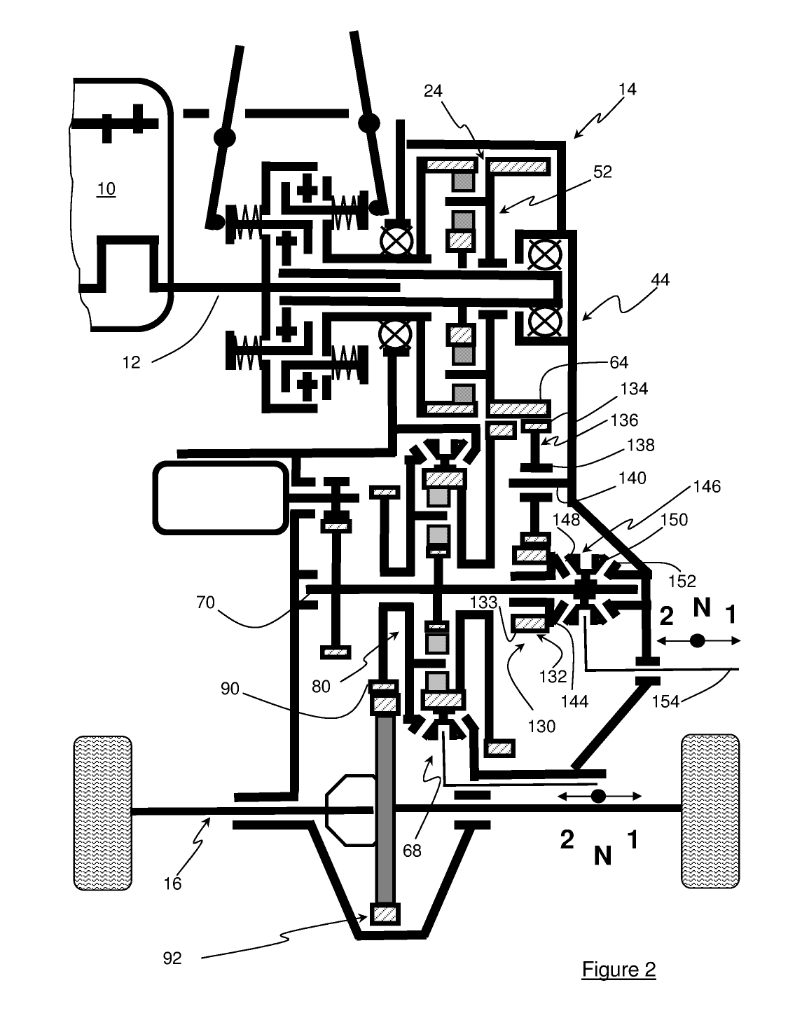

The variant of FIG. 2 differs from the example of FIG. 1 only in the separation of the thermal reverse control device and of the locking coupling.

Reverse gear device 130 comprises an externally toothed reverse gear wheel 132 with a toothed strip 133 that is free in rotation and fixed in translation on shaft 70. This wheel meshes with an external strip with teeth 134 of a connecting wheel 136 that cooperates by meshing with connecting strip 64 of planet gear carrier 52. This connecting wheel is carried by a tubular bearing 138 to be to free in rotate but fixed in translation on a shaft 140 carried by a fixed element 44 of the powertrain while being substantially parallel to shaft 70.

Reverse gear wheel 132 carries a coupling surface 144 that cooperates with a double-effect actuator 146 which is to free translate but fixed with rotation of shaft 70. This actuator carries a coupling surface 148 opposite surface 144 and another coupling surface 150 which cooperates with a coupling surface 152 carried by fixed element 44 of the powertrain.

This actuator is controlled in axial displacement along shaft 70 by a control 154 with a locking position (1) where shaft 70 is locked in rotation on fixed element 44 through cooperation of the two coupling surfaces 150 and 152, a driving position (2) where strip 132 of wheel 130 meshes with strip 134 of connecting gear wheel 136 through cooperation of the two coupling surfaces 144 and 148, and a neutral position (N) where the actuator is in contact with none of the coupling surfaces.

As mentioned above, in the configuration where control 154 actuates actuator 146 in position 1, the rotation of shaft 70 carrying sun gear 94 of machine epicyclic gear train 68 is locked due to the cooperation of coupling surfaces 150 and 152. In this configuration, machine epicyclic gear train 68 is used as a reducer and a shorter gearing down is achieved when using the thermal engine with its three speed ratios.

In order to put the vehicle in reverse using only the thermal engine, control 154 is actuated to bring actuator 146 into position 2. Due to the cooperation between the two coupling surfaces 144 and 148, the rotation of the gear wheel is transmitted to the actuator that in turn transmits it to shaft 70 and sun gear 94.

This allows obtaining a rotation of planet gear carrier 80 of machine epicyclic gear train 68 that is reverse to that of engine epicyclic gear train 24.

This reverse rotating motion is then transmitted to gear wheels 90 and 92 and to axle 16 by travelling the vehicle in reverse.

1-11. (canceled)

12. A powertrain for a hybrid type motor vehicle comprising a driving/receiving machine, a thermal engine, a speed variation device including an engine epicyclic gear train including a sun gear and a crown which are each connected to engine shaft by a controlled clutch and connected to a fixed part of the vehicle by a one-way automatic clutch and a planet gear carrier, and another epicyclic gear train mounted on a shaft parallel to engine shaft and connecting engine epicyclic gear train to a transmission track for motion transmission to a drive axle, a reverse control device for reversing the direction of rotation of planet gear carrier of the other epicyclic gear train from rotation of planet gear carrier of engine epicyclic gear train.

13. A powertrain as claimed in claim 12, wherein the reverse control device comprises a connecting gear wheel fixedly mounted on the shaft which meshes with a reverse gear wheel which is to free rotate and is axially movable on a gear wheel pin.

14. A powertrain as claimed in claim 13, wherein reverse gear wheel comprises a strip carrying teeth which cooperates with an additional strip carrying teeth of the planet gear carrier and with a strip carrying teeth of connecting gear wheel of shaft.

15. A powertrain as claimed in claim 14, wherein the reverse control device comprises a connecting gear wheel mounted to be free to rotates and fixed in translation on a gear wheel shaft, and a reverse gear wheel free to rotate and axially fixed on shaft.

16. A powertrain as claimed in claim 15, wherein the connecting gear wheel comprises a strip carrying teeth which cooperates with an additional strip carrying teeth of planet gear carrier of the engine epicyclic gear train and with a strip carrying teeth of the reverse gear wheel.

17. A powertrain as claimed in claim 12, wherein the reverse control device comprises a means for locking shaft in rotation.

18. A powertrain as claimed in claim 13, wherein the reverse control device comprises a means for locking shaft in rotation.

19. A powertrain as claimed in claim 14, wherein the reverse control device comprises a means for locking shaft in rotation.

20. A powertrain as claimed in claim 15, wherein the reverse control device comprises a means for locking shaft in rotation.

21. A powertrain as claimed in claim 16, wherein the reverse control device comprises a means for locking shaft in rotation.

22. A powertrain as claimed in claim 17, wherein the means for locking comprises a coupling surface carried by the reverse gear wheel and a coupling surface carried by a fixed element of the powertrain.

23. A powertrain as claimed in claim 18, wherein the means for locking comprises a coupling surface carried by the reverse gear wheel and a coupling surface carried by a fixed element of the powertrain.

24. A powertrain as claimed in claim 19, wherein the means for locking comprises a coupling surface carried by the reverse gear wheel and a coupling surface carried by a fixed element of the powertrain.

25. A powertrain as claimed in claim 20, wherein the means for locking comprises a coupling surface carried by the reverse gear wheel and a coupling surface carried by a fixed element of the powertrain.

26. A powertrain as claimed in claim 21, wherein the means for locking comprises a coupling surface carried by the reverse gear wheel and a coupling surface carried by a fixed element of the powertrain.

27. A powertrain as claimed in claim 17, wherein the means for locking comprises a coupling surface carried by an actuator, fixed in rotation and free to translate on locking shaft, and a coupling surface carried by a fixed element of the powertrain.

28. A powertrain as claimed in claim 18, wherein the means for locking comprises a coupling surface carried by an actuator, fixed in rotation and free to translate on locking shaft, and a coupling surface carried by a fixed element of the powertrain.

29. A powertrain as claimed in claim 19, wherein the means for locking comprises a coupling surface carried by an actuator, fixed in rotation and free to translate on locking shaft, and a coupling surface carried by a fixed element of the powertrain.

30. A powertrain as claimed in claim 20, wherein the means for locking comprises a coupling surface carried by an actuator, fixed in rotation and free to translate on locking shaft, and a coupling surface carried by a fixed element of the powertrain.

31. A powertrain as claimed in claim 21, wherein the means for locking comprises a coupling surface carried by an actuator, fixed in rotation and free to translate on locking shaft, and a coupling surface carried by a fixed element of the powertrain.

32. A powertrain as claimed in claim 27, wherein the actuator comprises a coupling surface which cooperates with a coupling surface linked to a reverse gear wheel.

33. A powertrain as claimed in claim 28, wherein the actuator comprises a coupling surface which cooperates with a coupling surface linked to a reverse gear wheel.

34. A powertrain as claimed in claim 29, wherein the actuator comprises a coupling surface which cooperates with a coupling surface linked to a reverse gear wheel.

35. A powertrain as claimed in claim 30, wherein the actuator comprises a coupling surface which cooperates with a coupling surface linked to a reverse gear wheel.

33. A powertrain as claimed in claim 31, wherein the actuator comprises a coupling surface which cooperates with a coupling surface linked to a reverse gear wheel.

36. A powertrain as claimed in claim 12, wherein the reverse control device comprises means for controlling axial displacement of the reverse gear wheel.

37. A powertrain as claimed in claim 13, wherein the reverse control device comprises means for controlling axial displacement of the reverse gear wheel.

38. A powertrain as claimed in claim 14, wherein the reverse control device comprises means for controlling axial displacement of the reverse gear wheel.

39. A powertrain as claimed in claim 27, wherein the reverse control device comprises means for controlling axial displacement of the actuator.

40. A powertrain as claimed in claim 32, wherein the reverse control device comprises means for controlling axial displacement of the actuator.

41. A powertrain as claimed in claim 36, wherein the reverse control device comprises means for controlling axial displacement of the actuator.
